(19) United States
(12) Patent Application Publication
(10) Pub. No.: US 2005/0217401 A1
(43) Pub. Date: Oct. 6, 2005

(54) Ball screw

(76) Inventors: Jurgen Osterlanger, Emskirchen (DE); Ralf Mayer, Herzogenaurach (DE)

Correspondence Address: OSTROLENK FABER GERB & SOFFEN, 1180 AVENUE OF THE AMERICAS, NEW YORK, NY, 100368403, US

(21) Appl. No.: 10/527,979

(22) PCT Filed: Aug. 13, 2003
(86) PCT No.: PCT/EP03/08965

§ 371 Date: Mar. 14, 2005

(30) Foreign Application Priority Data
Sep. 12, 2002 (DE) 10242297.4

(51) Int. Cl. F16H 1/24

(52) U.S. Cl. 74/424.87

(57) ABSTRACT

Ball screw having a spindle nut arranged on a spindle, balls arranged to roll in a thread path being formed by a first thread groove on the spindle and a second thread groove in the spindle nut. At least one deflecting piece arranged in a receptacle in the spindle nut, the piece including a deflecting channel for the return of the balls respectively form a run-out end to a run-in end of at least one common turn of the thread path. The deflecting piece is comprised of two partial deflecting pieces, wherein a parting plane divides the deflecting channel longitudinally, and the partial deflecting pieces are symmetric and have lock together hooks at their circumferential ends.

### FIELD OF THE INVENTION

The present invention relates to a ball screw.

DE 199 44 875 A1, for example, discloses a ball screw with a spindle and a nut surrounding the latter, and also with balls arranged in between, which are arranged in such a way that they can roll in a thread groove formed on the outer surface of the spindle and in a corresponding thread groove formed on the inner surface of the nut. Also provided on the nut are radial through-openings, in which deflecting pieces are fitted for the return of the balls respectively from a run-out end of a common turn of the thread grooves to a run-in end of this turn. The nut is configured as a one-piece sleeve with a circular-cylindrical casing and each fitted deflecting piece is arranged in the associated through-opening of the nut completely within the outer casing. Seen in cross section, the deflecting pieces are formed in an approximately U-shaped manner and have a base and two side plates adjoining the base. Formed between these side plates is a deflecting channel or a deflecting groove for the return of the balls. The deflecting pieces may be produced for example from plastic by the injection-molding process. The deflecting pieces may be given a spatially complicated form, which is intended to assist satisfactory deflection of the balls. The shaping of the deflecting pieces is subject to limits however. This is so because, if the deflecting piece is to be produced for example from plastic by the injection-molding process, it is not possible for shaping to take any form desired. For example, in the case of spatially very complicated shapings, problems may occur with the opening of the injection molding tool because of undercuts. Or very sophisticated slide molds are required, increasing the production costs for such deflecting pieces in such a way as to make their use problematical from a commercial aspect.

The object of the present invention is to provide a ball screw according to the features of the preamble of claim 1 in which the deflecting piece can be produced in a simple manner.

According to the invention, this object is achieved by the deflecting piece being composed of two partial deflecting pieces, a parting plane dividing the deflecting channel longitudinally. In the case of the ball screw according to the invention, complicated shapings of the deflecting pieces can take place without sophisticated injection molding tools being required. Even complicated spatial shapings which in the production of known one-part deflecting pieces necessitate pronounced undercuts, and consequently require sophisticated slide molds, are possible. The two partial deflecting pieces can be molded in one operation in a common injection molding tool. There is no longer any need for sophisticated undercuts or complicated slide molds. The two partial deflecting pieces merely need to be joined together and then they form the deflecting piece.

In the case of the customary individual deflection, a number of complete rows of balls which respectively extend over one turn are provided in the spindle nut. In this case, the deflecting piece reaches over this one turn.

However, complete rows of balls which extend over more than one turn, for example two turns, may also be provided. In this case, the deflecting piece reaches over two turns, the run-in end being formed on the side of the first turn and the run-out end being provided on the side of the second turn. Normally, individual deflections are also customary because it is only in this way that the forces acting in the respective rows of balls on account of the deflecting operation remain below a critical value. Above the critical value, undesired running noises or operational disruptions may occur because of jamming of the balls.

With the invention, on the other hand, the ball guiding surfaces on the deflecting pieces may be formed in such a way that the lifting of the balls out of the thread groove of the spindle takes place smoothly and with low forces. For this reason, the invention is also suitable for ball screws with rows of balls which extend for example over two turns.

The one side plate may be formed in one piece on the one partial deflecting piece and the other side plate may be formed in one piece on the other deflecting piece. The one partial deflecting piece may then have one part of the base and the other partial deflecting piece may have another part of the base, it being possible for the two parts of the base to complement one another to form the complete base of the deflecting channel of the deflecting piece.

In a particularly favorable way, the two partial deflecting pieces may be captively connected to one another, in particular by a film hinge. In this way there is no longer any need for sophisticated sorting of matching partial deflecting pieces. If a film hinge is to be provided, it can be provided in one operation with the production of the partial deflecting pieces. The film hinge is then preferably connected in one piece to both partial deflecting pieces. In this case, there is already satisfactory alignment of the two partial deflecting pieces in relation to one another. The two partial deflecting pieces then merely need to be folded together, the film hinge permitting a folding angle of 180°, so that the one partial deflecting piece can be folded for example by 180° until it fits onto the other partial deflecting piece. For simple production, and also for simple assembly of the deflecting pieces, it may be expedient for the two partial deflecting pieces to be formed point-symmetrically in a sectional plane arranged transversely to the parting plane, with respect to a point of symmetry lying in the parting plane. On account of the symmetry, there is no need for special orientation for installation of the deflecting pieces in the spindle nut.

Both side plates of the deflecting piece may be respectively provided at their free end, facing the thread groove of the spindle, with a blade for engagement between the ball and the thread groove of the threaded spindle, so that the effective forces during the deflection of the balls are reduced. The blades may have spatially demanding contours on the finished deflecting piece. The clear distance between the two free ends of the side plates may be made to be significantly less than the ball diameter. There are no longer difficulties in injection-molding, since the parting plane indeed passes through the deflecting channel, consequently the two partial deflecting pieces can also be produced with simple injection molding tools.

The two-part configuration of the deflecting piece also permits the formation on the deflecting piece of ball guiding surfaces which engage in the thread groove of the spindle, in order to lift the balls off from the thread groove of the spindle. In the case of known deflecting pieces, the blades mentioned further above, or else the ball guiding surfaces, cannot be produced, or only in an extremely sophisticated way, since the shaping requires demanding tools.

Both partial deflecting pieces may be respectively provided with a hook and with a hook receptacle, a hook and a hook receptacle of each of the two partial deflecting pieces being able to hook in one another, gripping one another. These hooks and hook receptacles may in particular be formed in one piece on the partial deflecting pieces and already be allowed for in the injection molding tool. The two partial deflecting pieces then merely need to be folded together, the respective hooks and hook receptacles hooking in one another or interlocking. The deflecting pieces are then ready to install and also cannot be separated from one another any longer without external intervention.

Preferably, the hook is provided at the one circumferential end of each partial deflecting piece and the hook receptacle is provided at the opposite, other circumferential end. This formation is suitable in particular for partial deflecting pieces according to the invention which are point-symmetrical to one another in the way described above. In this case, the two partial deflecting pieces can also be formed identically with the hooks and hook receptacles formed on them.

The deflecting piece is preferably produced from thermoplastic material by the injection-molding process.

The invention is explained in more detail below on the basis of an exemplary embodiment that is represented in altogether nine figures, in which:

FIG. 1 shows a deflecting piece according to the invention in a perspective representation,

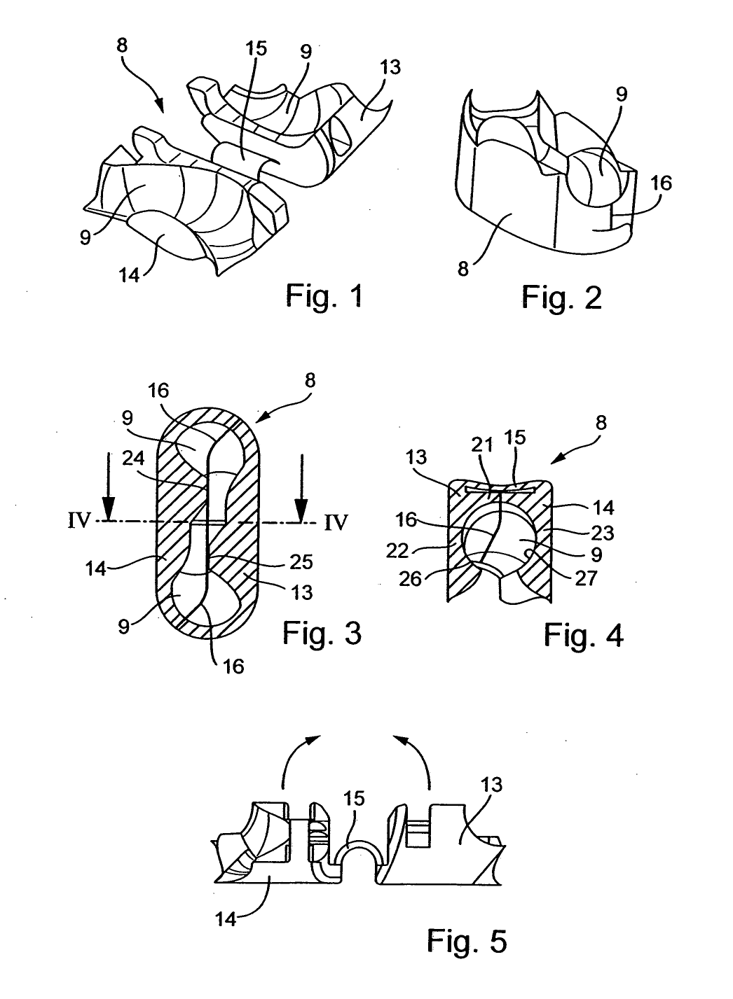

FIG. 2 shows the deflecting piece according to the invention as shown in FIG. 1, folded together,

FIG. 3 shows the deflecting piece according to the invention in an elevation,

FIG. 4 shows a section through the deflecting piece according to the invention from FIG. 3 along the line IV-IV,

FIG. 5 shows an elevation of the perspective representation of the deflecting piece according to the invention as shown in FIG. 1,

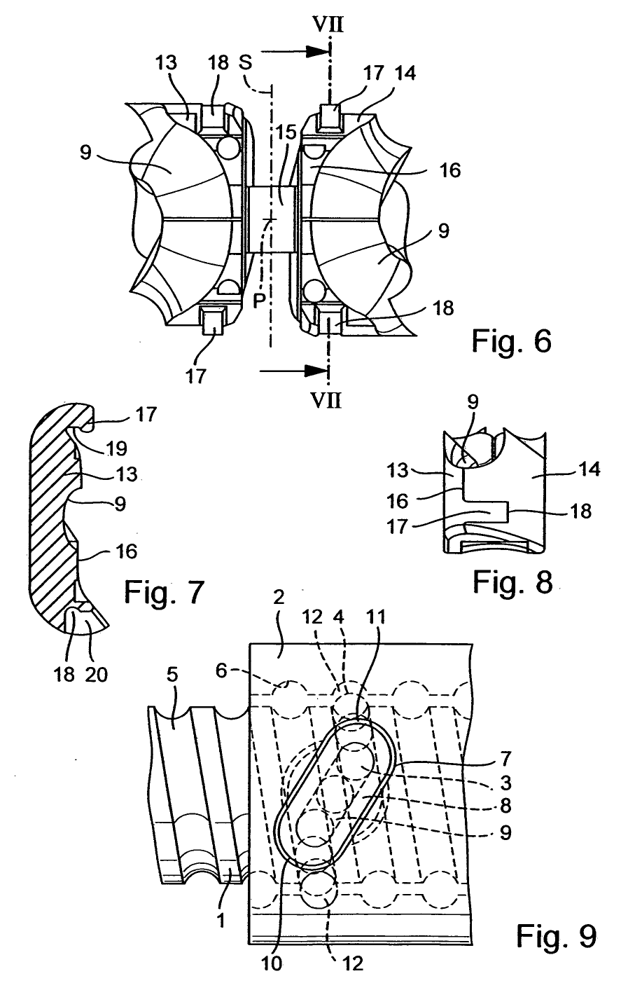

FIG. 6 shows a further elevation of the perspective representation as shown in FIG. 1,

FIG. 7 shows a section along the line VII—VII in FIG. 6,

FIG. 8 shows a detail of the deflecting piece according to the invention and

FIG. 9 shows a schematic representation of a ball screw according to the invention.

The ball screw according to the invention that is depicted in FIG. 9 comprises a spindle nut 2, arranged on a spindle 1, and balls 3, which are merely represented here by dashed lines. The balls 3 can roll on a thread path 4. The thread path 4 comprises a thread groove 5 formed on the spindle 1 and a thread groove 6 formed on the spindle nut 2. The spindle nut 1 is provided with a number of receptacles 7, arranged distributed over the circumference, for receiving deflecting pieces 2. Each deflecting piece comprises a deflecting channel 9 for the return of the balls 3 respectively from a run-out end 10 to a run-in end 11 of at least one common turn 12 of the thread path 4.

FIG. 1 clearly shows that the deflecting piece 8 is formed by two partial deflecting pieces 13, 14, which are captively connected to one another in one piece by means of a film hinge 15. FIG. 5 clearly shows for example the formation of the film hinge 15. The arrows provided in FIG. 5 show how the two partial deflecting pieces 13, 14 are folded together to form the deflecting piece 8 according to the invention.

FIG. 2 shows the folded-together deflecting piece 8 according to the invention.

FIG. 3 shows an elevation of the deflecting piece 8 according to the invention, a parting plane 16 clearly being arranged here, in the representation that is shown, in an approximately S-shaped manner along the deflecting channel 9 and dividing the detecting piece 8 into two partial deflecting pieces 13, 14. The parting plane 16 has been represented with a greater line thickness in order to illustrate the path it follows. The S-shaped path is favorable, since the two partial deflecting pieces 13, 14 have a parting plane which can simply be provided in the injection molding tool without excessive undercuts occurring.

FIG. 4 shows a cross section through the deflecting piece 8 according to the invention, it being clearly evident here that the film hinge 15 is pivoted by approximately 180° after a folding movement of the two partial deflecting pieces 13, 14 onto one another. The parting plane 16 is arranged in such a way that the two partial deflecting pieces 13, 14 can be produced alongside one another in a mold of an injection molding tool, no undercuts being provided on the two partial deflecting pieces 13, 14, or at least only undercuts which can be produced with a simple injection molding tool.

The representation in FIG. 6 reveals that the two partial deflecting pieces 13, 14 are formed point-symmetrically with respect to a point of symmetry P lying in the parting plane 16, the point of symmetry lying in a sectional plane S arranged transversely on the parting plane 16. On account of the symmetrical arrangement, identical partial deflecting pieces 13, 14 are produced. When the two partial deflecting pieces 13, 14 are folded together to form the deflecting piece 8 according to the invention, there is no need for special orientation for installation in the receptacle 7 of the spindle nut 2.

FIG. 6 also reveals that the two partial deflecting pieces 13, 14 are respectively provided with a hook 17 and a hook receptacle 18, a hook 17 and a hook receptacle 18 of each of the two partial deflecting pieces 13, 14 being able to hook in one another, gripping one another. On both partial deflecting pieces 13, 14, the hook 17 is formed in one piece at the one respective circumferential end and the hook receptacle 18 is formed in one piece at the other, opposite circumferential end.

FIG. 7 clearly shows the formation of the hook 17 and the formation of the hook receptacle 18 on the one partial deflecting piece 13. It is evident here that undercuts 19, 20 are provided. These undercuts 19, 20 are provided for satisfactory interlocking of the hooks 17 and the hook receptacles 18. However, these undercuts 19, 20 are such that simple injection molding tools or slides can be used. After completion of the two partial deflecting pieces 13, 14, a so-called forced demolding is then carried out, in which the partial deflecting pieces 13, 14 with their hook and with their hook receptacle 18 are elastically deformed to permit opening of the injection molding tool.

FIG. 8 shows the two interlocking partial deflecting pieces 13, 14 in detail.

FIG. 4 clearly shows that the deflecting channel 9 is bounded by a base 21 and two side plates 22, 23 of the deflecting piece 8, the one side plate 22 being formed in one piece on the one partial deflecting piece 13 and the other side plate 23 being formed in one piece on the other partial deflecting piece 14.

FIG. 3 reveals that the clear distance between the two free ends of the side plates 22, 23 is significantly less than the ball diameter. This constriction at the free ends is attributable to blades 24, 25, and ball guiding surfaces, which are formed in one piece on both side plates 22, 23, respectively at their free ends facing the spindle 1. These blades 24, 25 are provided for engagement between the balls 3 and the thread groove 5 of the spindle 1.

However, FIG. 4 also reveals that on both partial deflecting pieces 13, 14 there are formed ball guiding surfaces 26, 27 which engage in the thread groove 5 of the spindle 1, in order to lift the balls 3 off from the thread groove 5 of the spindle 1.

The deflecting piece according to the invention can be produced in a commercially particularly favorable way from thermoplastic material by the injection-molding process.

### List of Designations

1 spindle
2 spindle nut
3 ball
4 thread path
5 thread groove
6 thread groove
7 receptacle
8 deflecting piece
9 deflecting channel
10 run-out end
11 run-in end
12 turn
13 partial deflecting piece
14 partial deflecting piece
15 film hinge
16 parting plane
17 hook
18 hook receptacle
19 undercut
20 undercut
21 base
22 sideplate
23 sideplate
24 blade
25 blade
26 ball guiding surface
27 ball guiding surface

1. A ball screw comprising:
a spindle; a first thread groove formed on the spindle;
a spindle nut arranged on the spindle, a second thread groove formed in the spindle nut, the first and second thread grooves being respectively shaped and positioned to together form a thread path;
balls arranged such that they can roll in the thread path;
a receptacle in the spindle nut and opening to the spindle;
at least one deflecting piece arranged in the receptacle of the spindle nut, the deflecting piece including a deflecting channel shaped and directed for returning the balls in the thread path respectively from a run-out end to a run-in end of at least one common turn of the thread path, the deflecting piece is comprised of two partial deflecting pieces, and is shaped such that a parting plane divides the deflecting channel longitudinally.

2. The ball screw as claimed in claim 1, in which the deflecting channel is defined and bounded by a base and two spaced apart side plates attached to the base of the deflecting piece, the one of the side plates being formed on the one partial deflecting piece and the other of the side plates being formed on the other partial deflecting piece.

3. The ball screw as claimed in claim 1, in which the two partial deflecting pieces are captively connected to one another.

4. The ball screw as claimed in claim 1, wherein the two partial deflecting pieces are formed point-symmetrically in a sectional plane arranged transversely to the parting plane, with respect to a point of symmetry lying in the parting plane.

5. The ball screw as claimed in claim 1, wherein each of the side plates is provided at its respective free end, facing the thread groove of the spindle, with a respective blade for engagement between at least one of the balls the ball and the first thread groove of the spindle.

6. The ball screw as claimed in claim 1, wherein there is a clear distance between the two free ends of the side plates that is less than the ball diameter.

7. The ball screw as claimed in claim 1, further comprising the deflecting piece engaging the ball guiding surfaces to lift the balls off the first thread groove of the spindle.

8. The ball screw as claimed in claim 1, in which each of the partial deflecting pieces is respectively provided with a hook and with a hook receptacle, the hook and the hook receptacle of each of the two partial deflecting pieces being respectively so placed and shaped that each hook hooks into the hook receptacle of the other deflecting piece so that the deflecting pieces hook in one another and grip one another.

9. The ball screw as claimed in claim 6, wherein the hook is provided at one circumferential end of each partial deflecting piece and the hook receptacle is provided at an opposite, other circumferential end.

10. The ball screw as claimed in claim 1, wherein each of the deflecting pieces is produced in particular from thermoplastic material by an injection-molding process.

11. The ball screw as claimed in claim 3, wherein the deflecting pieces are connected by a film hinge.
